(19) United States
(12) Patent Application Publication
(10) Pub. No.: US 2022/0360093 A1
(43) Pub. Date: Nov. 10, 2022

(54) CHARGING AND DISCHARGING STRUCTURE, AND CHARGING METHOD

(71) Applicant: HuiZhou TCL Mobile Communication Co., Ltd., HuiZhou, Guangdong (CN)

(72) Inventors: Yu JIA, Huizhou, Guangdong (CN); Dingning WEN, Huizhou, Guangdong (CN); Hua ZHANG, Huizhou, Guangdong (CN); Longxi TAO, Huizhou, Guangdong (CN); Zhiqiang HU, Huizhou, Guangdong (CN)

(73) Assignee: HuiZhou TCL Mobile Communication Co., Ltd., HuiZhou, Guangdong (CN)

(21) Appl. No.: 17/621,254

(22) PCT Filed: Dec. 17, 2019
(86) PCT No.: PCT/CN2019/126063

§ 371 Date: Dec. 21, 2021

(30) Foreign Application Priority Data
Nov. 29, 2019 (CN) 201911204134.4

(51) Int. Cl. H02J 7/00; H01M 10/44; H01M 10/42

(52) U.S. Cl. CPC H02J 7/0013; H01M 10/441; H01M 10/425; H02J 7/0045; H01M 2010/4271

(57) ABSTRACT

A charging and discharging structure and a charging method. The charging and discharging structure comprises a main board (101), a processor (1011), a hardware charging interface (109), a sub circuit board (108), a flexible circuit board (107), a transistor (112), charging management circuits, and at least two energy storage modules (111); a charger (110) is electrically connected to the sub circuit board (108) by means of the hardware charging interface (109); the main board (101) is electrically connected to the energy storage modules (111) by means of the charging management circuits; when detecting that the charger (110) is electrically connected to the sub circuit board (108), the processor (1011) outputs a control instruction to the charging management circuits; upon receiving the control instruction, the charging management circuits control the energy storage modules (111) to perform charging and discharging.

### CROSS REFERENCE

This application claims the priority of Chinese Patent Application No. 201911204134.4, entitled “CHARGING AND DISCHARGING STRUCTURE, AND CHARGING METHOD”, filed on Nov. 29, 2019, the disclosure of which is incorporated herein by reference in its entirety.

### FIELD OF THE INVENTION

The present invention relates to a mobile terminal technology field, and more particularly, to a charging/discharging structure and a charging method.

### BACKGROUND

As the technology development progress, the mobile terminal, such as a tablet or a cell phone, become a necessary electronic device in our daily life. For a tablet or a cell phone, power storage module should have a huge capacity to allow the user to have longer hours of use. While it's possible for the conventional technology to increase the capacity of the power storage module, it also increase the time for charging the power storage module.

A conventional quick charge solution is to raise the charging power. That is, it is to raise the charging voltage or the charging current. For example, the quick charge 3.0 (Quick Charge, QC) requires a charge voltage of 18 W and the quick charge 4.0 requires a charge voltage of 27 W. Because the formula for calculating heats is P=I²R, where I is the charging current and R is the resistance of the charging circuit. If the charging current is increased to raise the charging efficiency, the heating problem will be severe.

In other words, the charging current of the conventional charger integrated circuit is limited due to the heating problem. Furthermore, the temperature increase also makes the power storage module unstable. This means that the charging efficiency of the mobile terminal cannot be largely raised. The conventional quick charge technology has the following issues: the temperature increase caused by the charging current will limit the charging current and thus influences the charging efficiency. This increases the charging time and makes the “quick charge” not quick.

### SUMMARY

### Technical Problem

One objective of an embodiment of the present invention is to provide a charging/discharging structure and a charging method, which has at least two charging modules. Furthermore, two power storage module connectors, two independent power storage modules, and the management integrated circuit are placed on the mobile terminal main board. Through this arrangement, two power storage modules could be independently charged at the same time. Therefore, each of the power storage modules could use the maximum charging voltage for a conventional power storage module without decreasing the power storage amount.

According to a first aspect of the present invention, a charging/discharging structure is disclosed. The charging/discharging structure comprises: a main board, a hardware charging connector, a sub-circuit board, a flexible printed circuit (FPC), a transistor, a charging management circuit and at least two power storage modules. The main board comprises a processor; wherein a charger is electrically connected to the sub-circuit board through the hardware charging connector; the sub-circuit board is electrically connected to the main board through the FPC; the main board is electrically connected to the power storage module through the charging management circuit; the transistor is electrically connected to the charging management circuit; when the processor detects that the charger is electrically connected to the sub-circuit board, the processor outputs a control command to the charging management circuit; and when the charging management circuit receives the control command, the charging management circuit controls a voltage and a current of the power storage modules to charge/discharge the power storage modules.

In some embodiments, a number of the charging management circuits matches a number of the power storage modules.

In some embodiments, the power storage modules comprise a first storage module and a second storage module, and the charging management circuit comprises a first charging management circuit and a second charging management circuit.

In some embodiments, the first charging management circuit is electrically connected to the first power storage module; the first charging management circuit increases the current according to a charging command outputted by the processor to charge the first power storage module; the second charging management circuit is electrically connected to the second power storage module; the second charging management circuit increases the current according to a charging command outputted from the processor to charge the second power storage module; and the first power storage module and the second power storage module are independently charged.

In some embodiments, the first charging management circuit controls the first power storage module to perform a discharging operation according to a discharging command outputted from the processor; the second charging management circuit controls the second power storage module to perform a discharging operation according to a discharging command outputted from the processor; and the first power storage module and the second power storage module are independently discharged.

In some embodiments, the charging management circuit is a charging management set, comprising a plurality of sub-charging management circuits; wherein a number of the sub-charging management circuits matches a number of the power management modules.

In some embodiments, the power storage modules comprise a first power storage module and a second power storage module; and the charging management circuit comprises a third charging management circuit and a fourth charging management circuit.

In some embodiments, the third charging management circuit is electrically connected to the fourth charging management circuit through the transistor; when the charging management circuit receives a charging command outputted by the processor, the transistor controls the third charging management circuit to be connected to the fourth charging management circuit such that the third charging management circuit increase a current according to the charging command to charge the first power storage module; the second charging management circuit increases a current according to the charging command to charge the second power storage module; and the first power storage module and the second power storage module are independently charged.

In some embodiments, when the charging management circuit receives a discharging command outputted by the processor, the transistor controls the third charging management circuit and the fourth charging management circuit to break their parallel connection such that the third charging management circuit controls the first power storage module to perform a discharging operation according to the discharging command; the fourth charging management circuit controls the second power storage module to perform a discharging operation according to the discharging command; and the first storage power and the second power storage module are independent and perform the discharging operations according to a predetermined order.

In some embodiments, the main board further comprises a power detection circuit electrically connected to the processor.

According to a second aspect of the present invention, a charging method applied in the above charging/discharging structure is disclosed.

The charging method comprises: when detecting that the at least two power storage modules meet a predetermined first condition, connecting the charger through the hardware charging connector to confirm that a mobile terminal charging system structure is in a charging state;

transferring a charging command to the charging management circuit such that the first charging management circuit charges the first power storage module according to a charging command; the second charging management circuit charges the second power storage module according to a charging command; wherein the first power storage module and the second power storage module are independently charged;

when detecting that the power storage modules meet a second condition, stop a charging operation.

In some embodiments, the first condition is that an overall power of the power storage modules is lower than a first threshold.

In some embodiments, the step where the charging management circuit controls the at least two power storage modules to perform a charging operation comprises: the first charging management circuit charges the first power storage module according to a charging command; and the second charging management circuit charges the second power storage module according to a charging command. The first power storage module and the second power storage module are independently charged.

According to a third aspect of the present invention, a charging method is disclosed.

The charging method comprises: detecting a remaining power of at least two power storage modules; and

utilizing a charging management circuit to output a control command to control the at least two power storage modules to perform a charging/discharging operation according to the remaining power of the at least two power storage modules and a predetermined rule; wherein the control command comprises a charging control command and a discharging control command.

In some embodiments, the at least two power storage modules comprise a first power storage module and a second power storage module, and the charging management circuit comprises a first charging management circuit and a second charging management circuit.

In some embodiments, the predetermined rule comprises a first predetermined rule and a second predetermined rule.

In some embodiments, the first predetermined rule comprises: setting a charging/discharging structure in a charge-requiring state if the remaining power of the at least two power storage modules is lower than the first predetermined threshold.

In some embodiments, the second predetermined rule comprises: if a difference between a remaining power of the first power storage module and a remaining power of the second power storage module is larger than the second predetermined threshold, comparing the remaining power of the first power storage module with the remaining power of the second power storage module, setting a predetermined power module state and outputting a control command to the charging management circuit according to the predetermined power module state.

In some embodiments, the step of comparing the remaining power of the first power storage module with the remaining power of the second power storage module and setting a predetermined power module state comprises:

when detecting the remaining power of the first power storage module is greater than the remaining power of the second power storage module, setting the predetermined storage module state of the first power storage module as a discharging state and setting the predetermined power storage state of the second power storage module as a charging state; and

when detecting the remaining power of the second power storage module is greater than the remaining power of the first power storage module, setting the predetermined storage module state of the second power storage module as a discharging state and setting the predetermined power storage state of the first power storage module as a charging state.

In some embodiments, the step of utilizing the charging management circuit to output the control command to control the at least two power storage modules to perform the charging/discharging operation according to the remaining power of the at least two power storage modules and the predetermined rule comprises:

utilizing the first charging management circuit to output a control command according to the predetermined power storage module state corresponding to the first power storage module to control the first power storage module to perform a charging/discharging operation; and

utilizing the second charging management circuit to output a control command according to the predetermined power storage module state corresponding to the second power storage module to control the second power storage module to perform a charging/discharging operation.

In contrast to the conventional art, the charging/discharging structure and charging method uses at least two power storage modules. Furthermore, two power storage module connectors, two independent power storage modules, and the management integrated circuit are placed on the mobile terminal main board.

Through this arrangement, two power storage modules could be independently charged at the same time. Therefore, each of the power storage modules could use the maximum charging voltage for a conventional power storage module without decreasing the power storage amount. The two separate power storage modules are independent and could work at the same time. Therefore, the charging time is equivalent to a half and thus the charging efficiency is raised. That is, an embodiment of the present invention divides a conventional power storage module into at least two power storage modules. The total power could be saved in the separated power storage modules remain the same or become larger. But in contrast to the conventional power storage module, with the same charging voltage, the charging current for each module could be reduced. Therefore, it can raise the charging efficiency and ensure the charging safety.

### BRIEF DESCRIPTION OF THE DRAWINGS

FIG. 1 is a diagram of a charging/discharging structure according to an embodiment of the present invention.

FIG. 2 is a diagram of a charging system according to an embodiment of the present invention.

FIG. 3 is a diagram of a discharging system according to an embodiment of the present invention.

FIG. 4 is a diagram of charging/discharging structure according to another embodiment of the present invention.

FIG. 5 is a diagram of a charging system according to another embodiment of the present invention.

FIG. 6 is a diagram of a discharging system according to another embodiment of the present invention.

FIG. 7 is a flow chart of a charging method according to an embodiment of the present invention.

FIG. 8 is a function block diagram of a mobile terminal according to an embodiment of the present invention.

FIG. 9 is a flow chart of a charging method according to another embodiment of the present invention.

### DETAILED DESCRIPTION OF PREFERRED EMBODIMENTS

The present disclosure a gamepad, a related control method and storage medium. These and other features, aspects and advantages of the present disclosure will become understood with reference to the following description, appended claims and accompanying figures.

Embodiments of the present invention proposes a charging/discharging structure and a charging method.

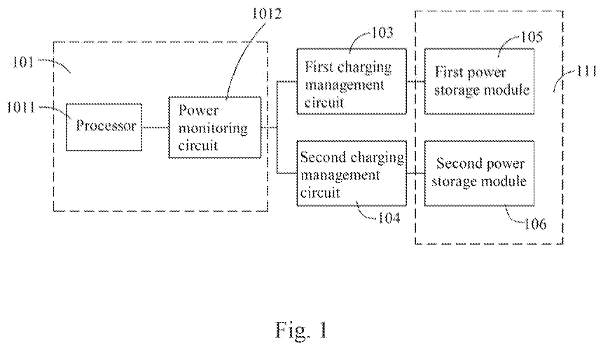

Please refer to FIG. 1. FIG. 1 is a diagram of a charging/discharging structure 1 according to an embodiment of the present invention. The charging/discharging structure 1 comprises: a main board 101, a first charging management circuit 103, a first power storage module 105, a second charging management circuit 104 and a second power storage module 106. The main board 101 comprises a processor 1011 and a power monitoring circuit 1012. The first charging management circuit 103 is electrically connected to the main board 101. The first power storage module 105 is electrically connected to the first power management circuit 103. The second charging management circuit 104 is electrically connected to the main board 101. The second power storage module 106 is electrically connected to the second charging management circuit 104.

The processor 1011 is used to output a charging command to the first charging management circuit 103 and the second charging management circuit 104 when the processor 1011 determines that the charging/discharging structure 1 is in a charging state.

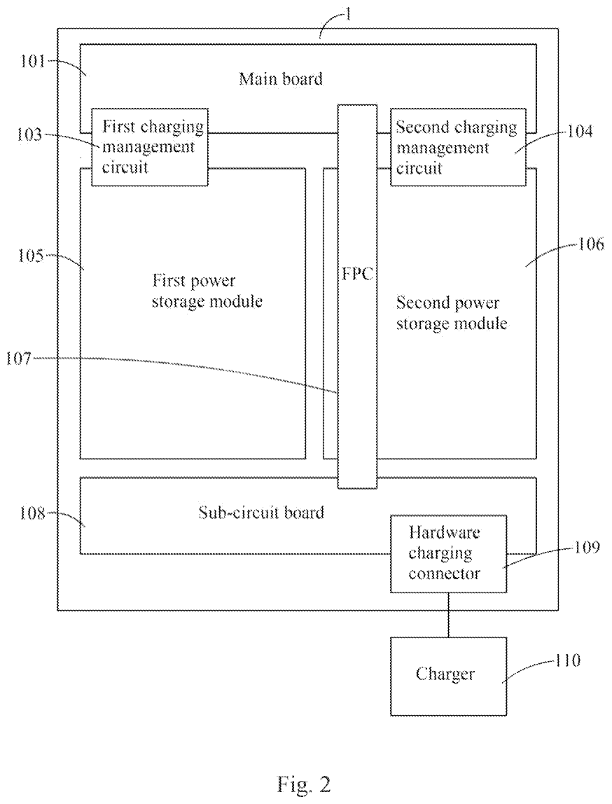

The charging state means that the processor 1011 controls the corresponding charger 110 to charge the first power storage module 105 and the second power storage module 106 in the charging/discharging structure 1 after the charging/discharging structure 1 establishes the electrical connection with the corresponding charger 110 (shown in FIG. 2) through the hardware charging connector 109 (shown in FIG. 2). When the charging/discharging structure 1 begins to enter into the charging state, it means that the charging/discharging structure 1 establishes the electrical connection with the corresponding charger but the processor 1011 not yet controls the charger to charge the first power storage module 105 and the second power storage module 106.

When the processor 1011 confirms that the charging/discharging structure 1 enters into the charging state, it means that the first power storage module 105 and the second power storage module 106 in the charging/discharging structure 1 need to be charged. Then, the processor 1011 outputs a charging command to the first charging management circuit 103 and the second charging management circuit 104. The charging command controls the first charging management circuit 103 and the second charging management circuit 104. The first charging management circuit 103 and the second charging management circuit 104 are controlled to control the current flowing from the corresponding charger into the first power storage module 105 and the second power storage module 106.

Before the charging/discharging structure 1 enters into the charging state, the charging/discharging structure 1, the first power storage module 105 and the second power storage module 106 in the charging/discharging structure 1 are independent and could provide a voltage to the processor 1011 in the charging/discharging structure 1 for its operation.

Because the first power storage module 105 and the second power storage module 106 are independent, the amount of stored current is the sum of the currents of the first storage module 105 and the second storage module 106. Thus, the charging voltage outputted by the charger for each of the divided power storage modules could be lower than the charging voltage for the conventional power storage module. That is, the charging/discharging structure 1 could be quickly charged by a comparative low charging voltage.

From the above, the charging/discharging structure of an embodiment of the present invention utilizes the processor to output a charging command to the charging management circuit (such as the first charging management circuit 103 or the second charging management circuit 104) when the processor determines that the charging/discharging structure enters into a charging state; control the current flowing from the charger to the power storage module to perform a charging operation; and set two independent charging management circuits (such as the first charging management circuit 103 and the second charging management circuit 104) and two power storage modules when the charging/discharging structure enters into the charging state. That is, an embodiment of the present invention divides a single power storage module into at least two power storage modules. The power stored in the divided power storage modules remain the same or become larger. But in contrast to the conventional power storage module, with the same charging voltage, the charging current for each module could be reduced. Therefore, it can raise the charging efficiency and ensure the charging safety.

In the embodiment shown in FIG. 1, the power storage module 111 comprises only two power storage modules. Please note, this is only an example, not a limitation of the present invention. The number of the power storage modules or the charging management circuits could be four, five, six or any other number according to the actual demands.

The charging/discharging structure 1 further comprises: a main board 101, a flexible printed circuit (FPC) 107, a sub-circuit board 108, a hardware charging connector 109 and a corresponding charger 110. The structure is shown in FIG. 2.

The hardware charging connector 109 is used to electrically connect to the corresponding charger 110. The hardware charging connector 109 is further used to electrically connect to the sub-circuit board 108. The sub-circuit board 108 is electrically connected to the main board 101 through the FPC 107.

When the at least two power storage modules 111 in the charging/discharging module 1 needs to be charged, the user electorally connect the charger 110 to the charging/discharging structure 1 through the hardware charging connector 109 such that the processor 1011 could control the charger 110 to output a charging voltage to the power storage modules 111 through hardware charging connector 109.

The processor 1011 is further used to confirm that the charging/discharging structure 1 enters into a charging state when the processor 1011 detects the charging/discharging structure 1 is electrically connected to the charger 110 through the hardware charging connector 109.

The processor 1011 could execute one of the following methods to confirm that the charging/discharging structure 1 enters into a charging state:

The first method: if the processor 1011 detects the charging/discharging structure 1 is electrically connected to the charger 110 through the hardware charging connector 109, then the processor 1011 confirms that the charging/discharging structure 1 enters into a charging state.

The second method: if the processor 1011 detects the charging/discharging structure 1 is electrically connected to the charger 110 through the hardware charging connector 109, then the processor 1011 further detects whether the connected charger 110 is the charger corresponding to the charging/discharging structure 1. If the connected charger 110 is the corresponding charger, then the processor 1011 confirms that the charging/discharging structure 1 enters into a charging state.

The third method: if the processor 1011 detects the charging/discharging structure 1 is electrically connected to the charger 110 through the hardware charging connector 109, then the processor 1011 detects whether the connected charger 110 is the quick-charge charger corresponding to the charging/discharging structure 1. If the connected charger 110 is the corresponding quick-charge charger, then the processor 1011 confirms that the charging/discharging structure 1 enters into a charging state.

As shown in FIG. 1, the charging/discharging structure 1 comprises a power detecting circuit 1012. The power detecting circuit 1012 is electrically connected to the processor 1011 and the at least two power storage modules 111.

The power detecting circuit 1012 is used to collect, in the charging state, the remaining power (charged power) of the first power storage module and the remaining power of the second power storage module and the total power.

The processor 1011 could execute one of the following three methods to determine whether to connect to the corresponding charger 110 to enter into the charging state:

The first method: a threshold is set in the processor 1011. If the power detecting circuit 1012 the total power of the two power storage modules 111 is lower than the predetermined threshold, the processor 1011 determines that the charging/discharging structure 1 needs to be connected to the corresponding charger 110 to enter into a charging state. For example, assume that the maximum powers of the first power storage module and the second power storage module are both 800 mah (Magawatt hour). If the remaining power of the first power storage module is 40 mah and the remaining power of the second power storage module is 30 mah, the processor 1011 determines that the charging/discharging structure 1 needs to be connected to the corresponding charger 110 to enter into a charging state.

The second method: a first threshold for the first storage module 105 is set in the processor 1011 and the second threshold for the second storage module 106 is also set in the processor 1011. Then, two scenarios are as follows:

The first scenario: if the power detecting circuit 1012 detects that the remaining power of the first power storage module 105 is lower than the first predetermined threshold, the processor 1011 determines that the charging/discharging structure 1 needs to be connected to the corresponding charger 110 to enter into a charging state. For example, assume that the maximum powers of the first power storage module and the second power storage module are both 800 mah (Magawatt hour) and the first predetermined threshold is 100 mah. If the remaining power of the first storage module is 90 mah, then the processor 1011 determines that the charging/discharging structure 1 needs to be connected to the corresponding charger 110 to enter into a charging state.

The second scenario: if the power detecting circuit 1012 detects that the remaining power of the second power storage module 106 is lower than the second predetermined threshold, the processor 1011 determines that the charging/discharging structure 1 needs to be connected to the corresponding charger 110 to enter into a charging state. For example, assume that the maximum powers of the first power storage module and the second power storage module are both 800 mah (Magawatt hour) and the second predetermined threshold is 100 mah. If the remaining power of the second storage module is 90 mah, then the processor 1011 determines that the charging/discharging structure 1 needs to be connected to the corresponding charger 110 to enter into a charging state.

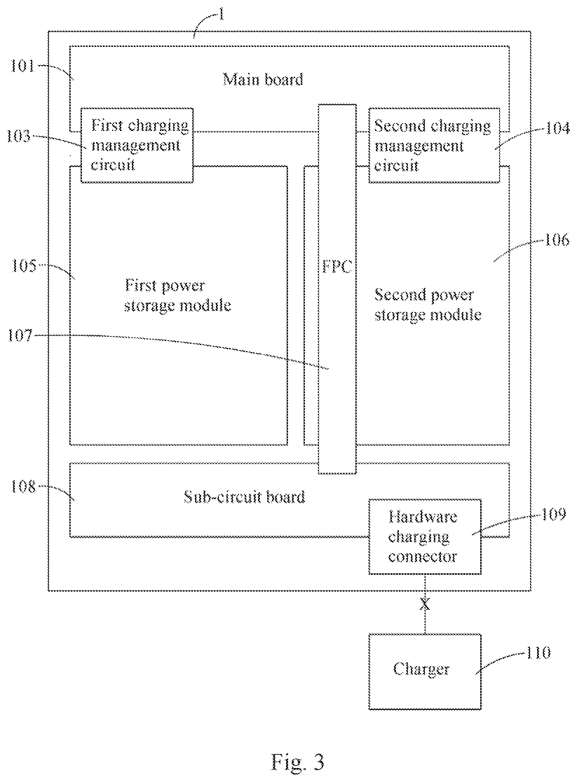

When the charger 110 finishes charging the power storage modules 111 in the charging/discharging structure 1, the charger 111 breaks the connection with the charging/discharging structure 1. The actual implementation is shown in FIG. 3;

The processor 1011 outputs a discharging command to the first charging management circuit 103 and the second management circuit 104 when the processor 1011 is used to detect whether the charging/discharging structure 1 enters into a discharging state.

The discharging state means that the charging/discharging structure 1 is discharged through the at least two power storage modules 111 to maintain its normal operation after the charging/discharging structure 1 breaks the connection with the charger 110.

When the processor 1011 detects that the charging/discharging structure 1 enters into a discharging state, it means that the charging process of the two power storage modules 111 is over. Then, the processor 1011 outputs a discharging command to the first charging management circuit 103 and the second charging management circuit 104. The discharging command is used to control the two power storage modules 111 to provide power to the main board 101 according to a predetermined order.

The processor 1011 is further used to confirm that the charging/discharging structure 1 enters into a discharging state when the processor 1011 detects that the hardware charging connector 109 breaks its connection with the corresponding charger 110.

The processor 1011 controls the two power storage modules 111 to perform a discharging operation through the first charging management circuit 103 and the second charging management circuit 104 according to a predetermined usage order to maintain the normal operation of the charging/discharging structure 1.

From the above, the charging/discharging structure of an embodiment of the present invention utilizes the processor to output a charging command to the charging management circuit (such as the first charging management circuit 103 or the second charging management circuit 104) when the processor determines that the charging/discharging structure enters into a charging state; control the current flowing from the charger to the power storage module to perform a charging operation; and set two independent charging management circuits (such as the first charging management circuit 103 and the second charging management circuit 104) and two power storage modules when the charging/discharging structure enters into the charging state. That is, an embodiment of the present invention divides a single power storage module into at least two power storage modules. The power stored in the divided power storage modules remain the same or become larger. But in contrast to the conventional power storage module, with the same charging voltage, the charging current for each module could be reduced. Therefore, it can raise the charging efficiency and ensure the charging safety.

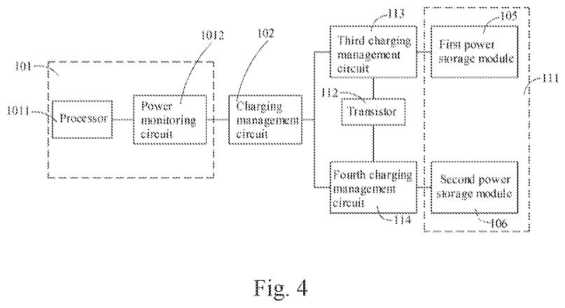

FIG. 4 is a diagram of charging/discharging structure 1 according to a second embodiment of the present invention. The charging/discharging structure 1 comprises: a main board 101, a first charging management circuit 102, a first power storage module 105 and a second power storage module 106. The main board 101 comprises a processor 1011 and a power detecting circuit 1012. The power detecting circuit 1012 is electrically connected to the first charging management circuit 102. The first charging management circuit 102 comprises a third charging management circuit 113 and a fourth charging management circuit 114, which are independent. The first charging management circuit 102 is electrically connected to the third charging management circuit 113 and the fourth charging management circuit 114. The third charging management circuit 113 is electrically connected to the fourth charging management circuit 114 through a transistor. The first power storage module 105 is electrically connected to the first charging management circuit 103 and the second power storage module 106 is electrically connected to the second charging management module 104. Here, the transistor is a MOSFET, which is used as a switch to control to establish or break the connection between the third charging management circuit 113 and the fourth charging management circuit 114.

The processor 1011 is used to output a charging command to the first charging management circuit 102, the first charging management circuit 103 and the second charging management circuit 104.

The charging state means that the processor 1011 controls the corresponding charger 110 to charge the first power storage module 105 and the second power storage module 106 in the charging/discharging structure 1 after the charging/discharging structure 1 establishes the electrical connection with the corresponding charger 110 through the hardware charging connector 109 (shown in FIG. 2). When the charging/discharging structure 1 begins to enter into the charging state, it means that the charging/discharging structure 1 establishes the electrical connection with the corresponding charger but the processor 1011 not yet controls the charger to charge the first power storage module 105 and the second power storage module 106.

When the processor 1011 confirms that the charging/discharging structure 1 enters into the charging state, it means that the first power storage module 105 and the second power storage module 106 in the charging/discharging structure 1 need to be charged. Then, the processor 1011 outputs a charging command to the first charging management circuit 102, the first charging management circuit 103 and the second charging management circuit 104. At this time, the third charging management circuit is electrically connected to the fourth charging management circuit through the transistor. When the charging management circuit receives the charging command outputted by the processor, the transistor connects the third charging management circuit and the fourth charging management circuit. The third charging management circuit increases the current according to the charging command outputted by the processor to charge the first power storage module. The second charging circuit increases the current according to the charging command outputted by the processor to charge the second power storage module. Here, the first power storage module and the second power storage module are independently charged.

Before the charging/discharging structure 1 enters into the charging state, the charging/discharging structure 1, the first power storage module 105 and the second power storage module 106 in the charging/discharging structure 1 are independent and could provide a voltage to the processor 1011 in the charging/discharging structure 1 for its operation.

Because the first power storage module 105 and the second power storage module 106 are independent, the amount of stored current is the sum of the currents of the first storage module 105 and the second storage module 106. Thus, the charging voltage outputted by the charger for each of the divided power storage modules could be lower than the charging voltage for the conventional power storage module. That is, the charging/discharging structure 1 could be quickly charged by a comparative low charging voltage.

From the above, the charging/discharging structure of an embodiment of the present invention utilizes the processor to output a charging command to the charging management circuit (such as the first charging management circuit 103 or the second charging management circuit 104) when the processor determines that the charging/discharging structure enters into a charging state; control the current flowing from the charger to the power storage module to perform a charging operation; and set two independent charging management circuits (such as the first charging management circuit 103 and the second charging management circuit 104) and two power storage modules when the charging/discharging structure enters into the charging state. That is, an embodiment of the present invention divides a single power storage module into at least two power storage modules. The power stored in the divided power storage modules remain the same or become larger. But in contrast to the conventional power storage module, with the same charging voltage, the charging current for each module could be reduced. Therefore, it can raise the charging efficiency and ensure the charging safety.

In the embodiment shown in FIG. 4, the power storage module 111 comprises only two power storage modules. Please note, this is only an example, not a limitation of the present invention. The number of the power storage modules or the charging management circuits could be four, five, six or any other number according to the actual demands.

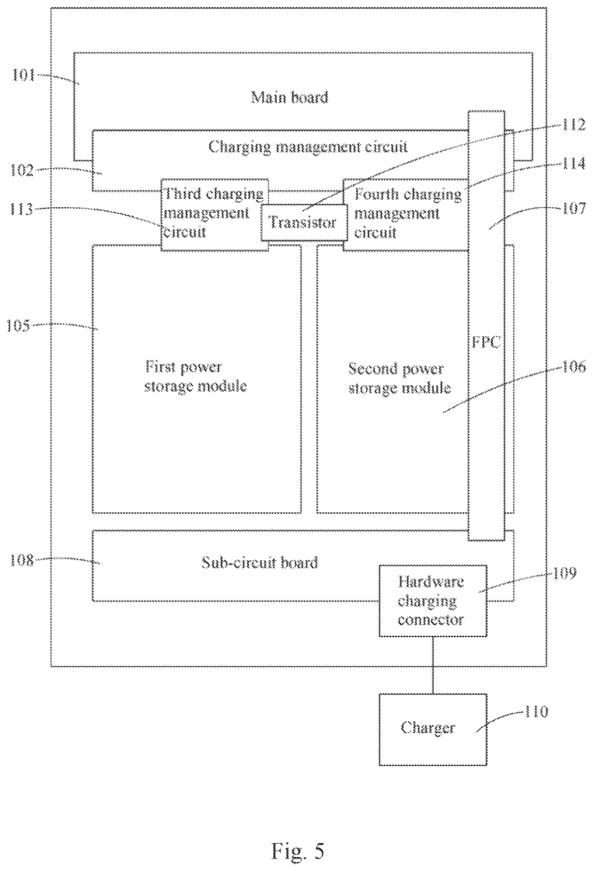

The charging/discharging structure 1 further comprises: a main board 101, a flexible printed circuit (FPC) 107, a sub-circuit board 108, a hardware charging connector 109 and a corresponding charger 110. The actual structure is shown in FIG. 5 and the related operations are already illustrated in the first embodiment and thus further illustrations are omitted here.

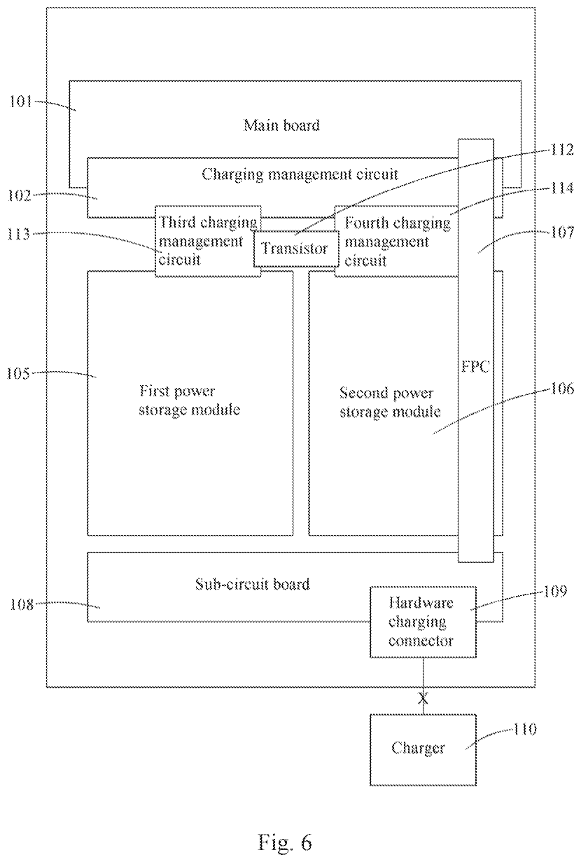

When the charger 110 finishes charging the at least two power storage modules 111 in the charging/discharging structure 1, the charger 111 breaks the connection with the charging/discharging structure 1. The actual implementation is shown in FIG. 6:

The processor 1011 outputs a discharging command to the first charging management circuit 102, the third charging management circuit 113 and the fourth management circuit 114 when the processor 1011 is used to detect whether the charging/discharging structure 1 enters into a discharging state.

When the first charging management circuit 102 receives the discharging command outputted by the processor 1011, the MOSFET breaks the connection between the third charging management circuit 113 and the fourth charging management circuit 114. The third charging management circuit 113 controls the first power storage module 105 to perform a discharging operation according to the discharging command outputted by the processor 1101. The fourth charging management circuit 114 controls the second power storage module 106 to perform a discharging operation according to the discharging command outputted by the processor 1101. Here, the first power storage module 105 and the second power storage module 106 are independently discharged according to a predetermined order.

The discharging state means that the charging/discharging structure 1 is discharged through the at least two power storage modules 111 to maintain its normal operation after the charging/discharging structure 1 breaks the connection with the charger 110.

When the processor 1011 detects that the charging/discharging structure 1 enters into a discharging state, it means that the charging process of the two power storage modules 111 is over. Then, the processor 1011 outputs a discharging command to the first charging management circuit 102, the first charging management circuit 113 and the second charging management circuit 114. The discharging command is used to control the at least two power storage modules 111 to provide power to the main board 101 according to a predetermined order.

The processor 1011 is further used to confirm that the charging/discharging structure 1 enters into a discharging state when the processor 1011 detects that the hardware charging connector 109 breaks its connection with the corresponding charger 110.

The processor 1011 controls the at least two power storage modules 111 to perform a discharging operation through the third charging management circuit 113 and the fourth charging management circuit 114 according to a predetermined usage order to maintain the normal operation of the charging/discharging structure 1.

From the above, the charging/discharging structure of an embodiment of the present invention utilizes the processor to output a charging command to the charging management circuit (such as the first charging management circuit 103 or the second charging management circuit 104) when the processor determines that the charging/discharging structure enters into a charging state; control the current flowing from the charger to the power storage module to perform a charging operation; and set two independent charging management circuits (such as the first charging management circuit 103 and the second charging management circuit 104) and two power storage modules when the charging/discharging structure enters into the charging state. That is, an embodiment of the present invention divides a single power storage module into at least two power storage modules. The power stored in the divided power storage modules remain the same or become larger. But in contrast to the conventional power storage module, with the same charging voltage, the charging current for each module could be reduced. Therefore, it can raise the charging efficiency and ensure the charging safety.

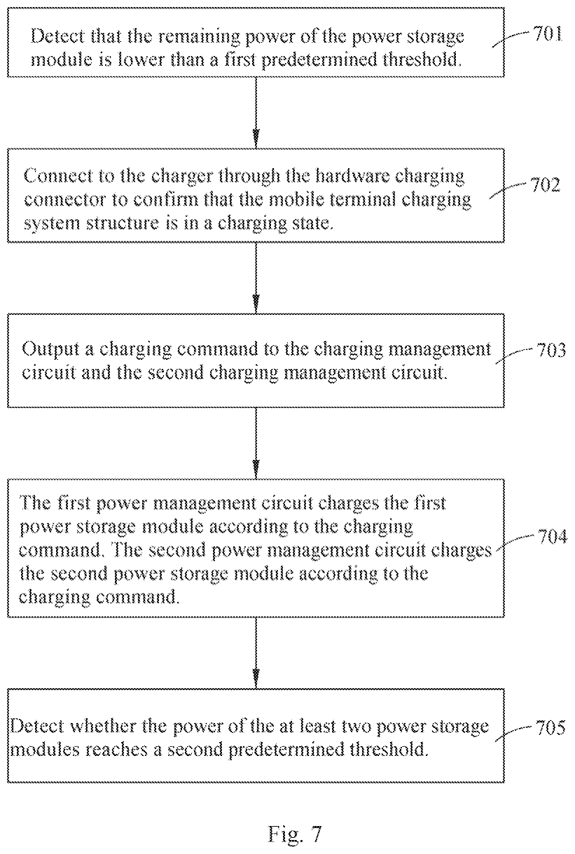

FIG. 7 is a flow chart of a charging method according to an embodiment of the present invention. The flow chart comprises following steps:

Step 701: Detect that the remaining power of the power storage module is lower than a first predetermined threshold.

The first predetermined threshold is set in the processor 1011. When the power detecting circuit 1012 detects that the total power of the at least two power storage modules 111 is lower than the first predetermined threshold. Assume that the maximum powers of the first power storage module and the second power storage module are both 800 mah and the first predetermined threshold is 100 mah. When the remaining power of first power storage module is 40 mah and the remaining power of second power storage module is 30 mah, then the processor 1011 determines that the charging/discharging structure 1 needs to be connected to the corresponding charger 110 to enter into a charging state.

Step 702: Connect to the charger through the hardware charging connector to confirm that the mobile terminal charging system structure is in a charging state.

The processor 1011 could execute one of the following methods to confirm that the charging/discharging structure 1 enters into a charging state:

The first method: if the processor 1011 detects the charging/discharging structure 1 is electrically connected to the charger 110 through the hardware charging connector 109, then the processor 1011 confirms that the charging/discharging structure 1 enters into a charging state.

The second method: if the processor 1011 detects the charging/discharging structure 1 is electrically connected to the charger 110 through the hardware charging connector 109, then the processor 1011 further detects whether the connected charger 110 is the charger corresponding to the charging/discharging structure 1. If the connected charger 110 is the corresponding charger, then the processor 1011 confirms that the charging/discharging structure 1 enters into a charging state.

The third method: if the processor 1011 detects the charging/discharging structure 1 is electrically connected to the charger 110 through the hardware charging connector 109, then the processor 1011 detects whether the connected charger 110 is the quick-charge charger corresponding to the charging/discharging structure 1. If the connected charger 110 is the corresponding quick-charge charger, then the processor 1011 confirms that the charging/discharging structure 1 enters into a charging state.

Step 703: Output a charging command to the charging management circuit and the second charging management circuit.

After the processor 1011 confirms that the charging/discharging structure 1 enters into the charging state, the processor 1011 outputs a charging command to the charging management circuit 1 and the second charging management circuit. The charging command is used to control the at least two power storage modules 111 to enter into the charging state through the charging management circuit 1 and the second charging management circuit.

Step 704: The first power management circuit charges the first power storage module according to the charging command. The second power management circuit charges the second power storage module according to the charging command. Here, the first power storage module and the second power storage module are independently charged.

Step 705: Detect whether the power of the at least two power storage modules 111 reaches a second predetermined threshold. If yes, then stop charging.

A second predetermined threshold is set in the processor 1011. When the power detecting circuit 1012 detects that the total power of the at least two power storage modules 111 reaches a second predetermined threshold, the processor 1011 determines that the charging/discharging structure 1 needs to break its connection with the charger 110 to cease the charging state. Assume that the maximum powers of the first power storage module and the second power storage module are both 800 mah and the second predetermined threshold is 1600 mah. When the total power of the at least two power storage modules 111 reaches 1600 mah, the processor 1011 determines that the charging/discharging structure 1 needs to break its connection with the charger 110 to cease the charging operation.

From the above, the charging/discharging structure of an embodiment of the present invention utilizes the processor to output a charging command to the charging management circuit when the processor determines that the charging/discharging structure enters into a charging state; control the current flowing from the charger to the power storage module to perform a charging operation; and set two independent charging management circuits and two power storage modules when the charging/discharging structure enters into the charging state. That is, an embodiment of the present invention divides a single power storage module into at least two power storage modules. The power stored in the divided power storage modules remain the same or become larger. But the charging voltage outputted from the charger could be reduced. This could prevent the hearing problem caused by using a huge charging current/low voltage to quick charge the charging/discharging structure.

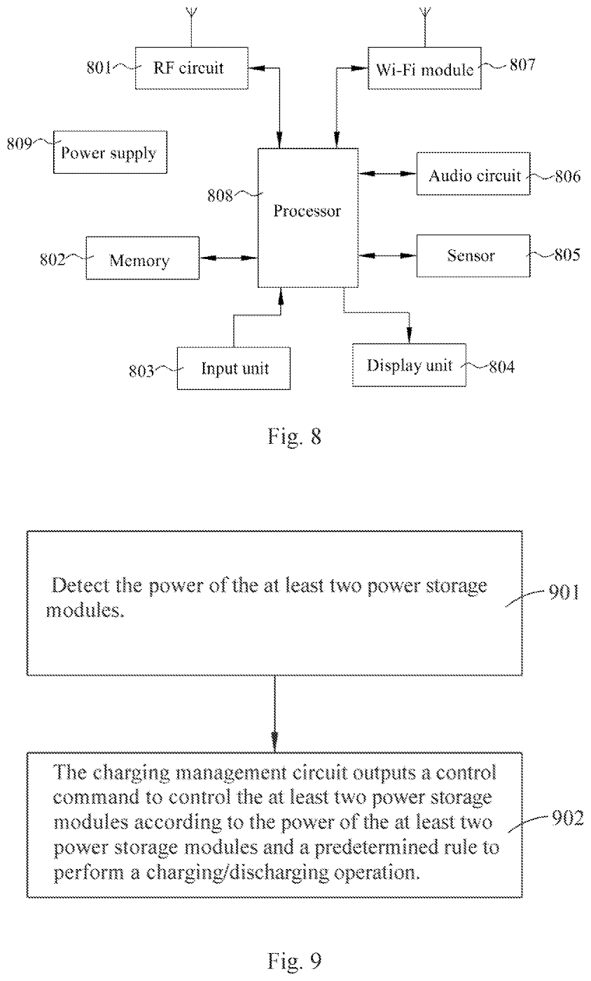

FIG. 9 is a flow chart of a charging method according to another embodiment of the present invention. The charging method could be used in the charging/discharging structure in FIG. 1.

Step 901: Detect the power of the at least two power storage modules.

In this embodiment, the remaining powers of the at least two power storage modules are added up to get the power of the at least two power storage modules.

The at least two power storage modules comprise the first power storage module 105 and the second power storage module 106. The charging management circuit is the first charging management circuit 103 and the second charging management circuit 104. In this embodiment, the power detecting circuit 1012 adds up the remaining power of the first power storage module 105 and the remaining power of the second power storage module 106 to obtain the power of the at least two power storage modules.

Step 902: The charging management circuit outputs a control command to control the at least two power storage modules according to the power of the at least two power storage modules and a predetermined rule to perform a charging/discharging operation. Here, the control command comprises a charging control command and a discharging control command.

The at least two power storage modules comprise the first power storage module 105 and the second power storage module 106. The charging management circuit is the first charging management circuit 103 and the second charging management circuit 104.

This embodiment could be implemented by the following four methods:

The first method: The predetermined rule comprises a first predetermined rule and a second predetermined rule.

The first predetermined rule: If the power of the first power storage module and the second power storage module is lower than a first threshold, set the condition of the charging/discharging structure 1 as a charge-requiring state. For example, assume the maximum powers of the first power storage module and the second power storage module are both 800 mah and the first predetermined threshold is 900 mah. If the remaining power of the first power storage module is 400 mah and the remaining power of the second power storage module is 200 mah, the condition of the charging/discharging structure 1 is set as the charge-requiring state. After the condition of the charging/discharging structure 1 is set as the charge-requiring state, the user could establish the connection between the hardware charging connector 109 and the corresponding charger 110 to perform the charging operation.

The second predetermined rule: If the difference between the remaining power of the first power storage module 105 and the remaining power of the second power storage module 106 is larger than a second predetermined threshold, then compare the remaining power of the first power storage module 105 with the remaining power of the second power storage module 106, set a predetermined power storage module state, and output a control command to the charging management circuit according to the predetermined power storage module state. In this embodiment, if the remaining power of the first power storage module 105 is larger than the remaining power of the second power storage module 106, then the predetermined power storage module state of the first power storage module 105 is set as a discharging state and the predetermined power storage module state of the second power storage module 106 is set as a charging state. If the remaining power of the second power storage module 106 is larger than the remaining power of the first power storage module 105, then the predetermined power storage module state of the first power storage module 105 is set as a charging state and the predetermined power storage module state of the second power storage module 106 is set as a discharging state. For example, assume the maximum powers of the first power storage module 105 and the second power storage module 106 are both 800 mah and the second predetermined threshold is 300 mah. If the remaining power of the first power storage module 105 is 200 mah and the remaining power of the second power storage module 106 is 600 mah, this means the difference between them is larger than the predetermined threshold 300 mah and the remaining power of the second power storage module 106 is larger than the remaining power of the first power storage module 105. Thus, the predetermined power storage module state of the first power storage module 105 is set as a charging state and the predetermined power storage module state of the second power storage module 106 is set as a discharging state.

The first charging management circuit 103 outputs a control command according to the predetermined power storage module corresponding to the first power storage module 105 to control the first power storage module 105 to perform a charging/discharging operation. The second charging management circuit 104 outputs a control command according to the predetermined power storage module corresponding to the second power storage module 106 to control the first power storage module 106 to perform a charging/discharging operation. For example, if the predetermined power storage module state of the first power storage module 105 is the discharging state, the first charging management circuit 103 controls the first power storage module 105 to perform a discharging operation. If the predetermined power storage module state of the first power storage module 105 is the charging state, the first charging management circuit 103 controls the first power storage module 105 to perform a charging operation. If the predetermined power storage module state of the second power storage module 106 is the discharging state, the second charging management circuit 104 controls the second power storage module 106 to perform a discharging operation. If the predetermined power storage module state of the second power storage module 106 is the charging state, the second charging management circuit 104 controls the second power storage module 106 to perform a charging operation.

The second method: The predetermined rule comprises a first predetermined rule and a second predetermined rule.

The first predetermined rule: If the power of the first power storage module and the second power storage module is lower than a first threshold, set both the predetermined power storage module states of the first power storage module 105 and the second power storage module 106 as the charging state. For example, assume the maximum powers of the first power storage module 105 and the second power storage module 106 are both 800 mah and the first predetermined threshold is 400 mah. When the remaining power of the first power storage module 105 is 100 mah and the remaining power of the second power storage module 106 is 200 mah, then the predetermined power storage module states of the first power storage module 105 and the second power storage module 106 are both set as the charging state. After the predetermined power storage module states of the first power storage module 105 and the second power storage module 106 are both set as the charging state, the user could connect the charging/discharging structure 1 to the corresponding charger 110 through the hardware charging connector 109 to perform a charging operation.

The second predetermined rule: If the difference between the remaining power of the first power storage module 105 and the remaining power of the second power storage module 106 is larger than a second predetermined threshold, then compare the remaining power of the first power storage module 105 with the remaining power of the second power storage module 106, set a predetermined power storage module state, and output a control command to the charging management circuit according to the predetermined power storage module state. In this embodiment, if the remaining power of the first power storage module 105 is larger than the remaining power of the second power storage module 106, then the predetermined power storage module state of the first power storage module 105 is set as a charging and discharging state and the predetermined power storage module state of the second power storage module 106 is set as a charging state. If the remaining power of the second power storage module 106 is larger than the remaining power of the first power storage module 105, then the predetermined power storage module state of the first power storage module 105 is set as a charging state and the predetermined power storage module state of the second power storage module 106 is set as a charging and discharging state. For example, assume the maximum powers of the first power storage module 105 and the second power storage module 106 are both 800 mah and the second predetermined threshold is 30 mah. If the remaining power of the first power storage module 105 is 50 mah and the remaining power of the second power storage module 106 is 90 mah, this means the difference between them is larger than the predetermined threshold 30 mah and the remaining power of the second power storage module 106 is larger than the remaining power of the first power storage module 105. Thus, the predetermined power storage module state of the first power storage module 105 is set as a charging state and the predetermined power storage module state of the second power storage module 106 is set as a charging and discharging state.

The first charging management circuit 103 outputs a control command according to the predetermined power storage module corresponding to the first power storage module 105 to control the first power storage module 105 to perform a charging/discharging operation. The second charging management circuit 104 outputs a control command according to the predetermined power storage module corresponding to the second power storage module 106 to control the first power storage module 106 to perform a charging/discharging operation. For example, if the predetermined power storage module state of the first power storage module 105 is the discharging state, the first charging management circuit 103 controls the first power storage module 105 to perform a discharging operation. If the predetermined power storage module state of the first power storage module 105 is the charging state, the first charging management circuit 103 controls the first power storage module 105 to perform a charging operation. If the predetermined power storage module state of the first power storage module 105 is the charging and discharging state, the first charging management circuit 103 controls the first power storage module 105 to perform a charging and charging operation to provide power to the terminal. If the predetermined power storage module state of the second power storage module 106 is the discharging state, the second charging management circuit 104 controls the second power storage module 106 to perform a discharging operation. If the predetermined power storage module state of the second power storage module 106 is the charging state, the second charging management circuit 104 controls the second power storage module 106 to perform a charging operation. If the predetermined power storage module state of the second power storage module 106 is the charging and discharging state, the second charging management circuit 104 controls the second power storage module 106 to perform a charging and charging operation to provide power to the terminal.

The third method: The predetermined rule is setting the predetermined power storage module states of the first power storage module 105 and the second power storage module 106 as the charging state if the total power of the first power storage module 105 and the second power storage module 106 is lower than a predetermined threshold. Then, the charging/discharging structure 1 is connected to the charger 110 through the hardware charging connector 109. The first charging management circuit 103 controls the first power storage module 105 to perform a charging operation. The second charging management circuit 104 controls the second power storage module 106 to perform a charging operation. For example, assume the maximum powers of the first power storage module 105 and the second power storage module 106 are both 800 mah and the predetermined threshold is 100 mah. If the remaining power of the first power storage module 105 is 40 mah and the remaining power of the second power storage module 106 is 30 mah, this means the total power of the first power storage module 105 and the second power storage module 106 is lower than the predetermined threshold. The processor 1011 determines that the charging/discharging 1 needs to be connected to the charger 110 to enter into the charging state. Then, the first charging management circuit 103 controls the first power storage module 105 to perform a charging operation and the second charging management circuit 104 controls the second power storage module 106 to perform a charging operation.

The fourth method: the predetermined rule comprises a first predetermined rule and a second predetermined rule.

The first predetermined rule: If the power of the first power storage module and the second power storage module is larger than a first predetermined threshold, set the state of the charging/discharging structure 1 as the charging state. For example, assume the maximum powers of the first power storage module 105 and the second power storage module 106 are both 800 mah and the first predetermined threshold is 1500 mah. If the remaining power of the first power storage module 105 is 800 mah and the remaining power of the second power storage module 106 is 750 mah, the state of the charging/discharging structure 1 is set as the charging state.

The second predetermined rule: compare the remaining power of the first power storage module 105 with the remaining power of the second power storage module 106, set the predetermined power storage module state, and output a control command to the charging management circuit according to the predetermined power storage module state.

If the remaining power of the first power storage module 105 is larger than the remaining power of the second power storage module 106, then the predetermined power storage module state of the first power storage module 105 is firstly set as the discharging state and the predetermined power storage module state of the second power storage module 106 is set as a waiting state. If the remaining power of the second power storage module 106 is larger than the remaining power of the first power storage module 105, then the predetermined power storage module state of the second power storage module 106 is firstly set as the discharging state and the predetermined power storage module state of the first power storage module 105 is set as a waiting state. For example, assume the maximum powers of the first power storage module 105 and the second power storage module 106 are both 800 mah. If the remaining power of the first power storage module 105 is 800 mah and the remaining power of the second power storage module 106 is 750 mah, this means that the remaining power of the first power storage module 105 is larger than the remaining power of the second power storage module 106. Then, the predetermined power storage module state of the first power storage module 105 is firstly set as the discharging state and the predetermined power storage module state of the second power storage module 106 is set as the waiting state.

The first charging management circuit 103 outputs a control command according to the predetermined power storage module state of the first power storage module 105 to control the first power storage module 105 to perform a charging/discharging operation. The second charging management circuit 104 outputs a control command according to the predetermined power storage module state of the second power storage module 106 to control the second power storage module 106 to perform a charging/discharging operation. For example, when the predetermined storage module state of the first power storage module 105 is the discharging state, the first charging management circuit 103 controls the first power storage module 105 to perform a discharging operation to provide power to the terminal. When the predetermined storage module state of the second power storage module 106 is the discharging state, the second charging management circuit 104 controls the second power storage module 106 to perform a discharging operation to provide power to the terminal.

From the above, the charging/discharging structure of an embodiment of the present invention utilizes the processor to output a charging command to the charging management circuit when the processor determines that the charging/discharging structure enters into a charging state; control the current flowing from the charger to the power storage module to perform a charging operation; and set two independent charging management circuits and two power storage modules when the charging/discharging structure enters into the charging state. That is, an embodiment of the present invention divides a single power storage module into at least two power storage modules. The power stored in the divided power storage modules remain the same or become larger. But the charging voltage outputted from the charger could be reduced. This could prevent the hearing problem caused by using a huge charging current/low voltage to quick charge the charging/discharging structure.

The charging/discharging structure and the charging method according to an embodiment of the present invention could be implemented in a mobile terminal, which is shown in FIG. 8. The mobile terminal could be a mobile phone, a calculator, a digital broadcast terminal, information transceiver equipment, a game controller, a tablet, a medical equipment, a bodybuilding equipment, or a personal digital assistance.

FIG. 8 is a function block diagram of a mobile terminal according to the fourth embodiment of the present invention. The mobile terminal comprises a radio frequency (RF) circuit 801, a memory 802 comprising one or more computer readable media, an input unit 803, a display unit 804, a sensor 805, an audio circuit 806, a wireless fidelity (Wi-Fi) module 807, a processor 808 comprising one or more processing cores, a power supply 809, etc. Those skilled in the art would understand that the mobile terminal is not limited to the structure of the mobile terminal shown in FIG. 8. The mobile terminal may comprise more or less components than those illustrated in the figure, or some components may be combined, or the mobile terminal may have different component arrangements.

The RF circuit 801 may be configured to receive and send a signal during an information receiving and sending process or a conversation process. Specifically, after receiving downlink information from a base station, the RF circuit 801 delivers the downlink information to one or more processors 880 for processing, and sends related uplink data to the base station. Generally, the RF circuit 801 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 801 may also communicate with a network and another device by wireless communication. The wireless communication may use any communications standard or protocol, which includes, but is not limited to, a Global System for Mobile communications (GSM), an Enhanced Data GSM Environment (EDGE), a Wideband Code Division Multiple Access (WCDMA), a Code Division Access (CDMA), a Time Division Multiple Access (TDMA), a Wireless Fidelity (Wi-Fi) such as IEEE 802.11a, IEEE 802.11b, IEEE802.11g and IEEE 802.11n, a Voice over Internet Protocol (VoIP), a Worldwide Interoperability for Microwave Access (Wi-Max), any other protocols for e-mail, instant communication and short message, and the like.

The memory 802 may be configured to store a software program and module. The processor 808 runs the software program and module stored in the memory 802, to implement various functional applications and data processing. The memory 802 may mainly include a program storage area and a data storage area. The program storage area may store an operating system, an application program required by at least one function (such as a sound playback function and an image display function), and the like. The data storage area may store data (such as audio data and an address book) created according to use of the mobile terminal, and the like. In addition, the memory 802 may include a high speed random access memory, and may also include a non-volatile memory, such as at least one magnetic disk memory, a flash memory device, or another volatile solid-state memory. Correspondingly, the memory 802 may further include a memory controller, so that the processor 808 and the input unit 803 access the memory 802.

The input unit 803 may be configured to receive input digit or character information, and generate keyboard, mouse, joystick, optical, or track ball signal input related to the user setting and function control. Specifically, the input unit 803 may include a touch-sensitive surface and other input device. The touch-sensitive surface may also be referred to as a touch screen or a touch panel, and may collect a touch operation of a user on or near the touch-sensitive surface (such as an operation of a user on or near the touch-sensitive surface by using any suitable object or attachment, such as a finger or a stylus), and drive a corresponding connection apparatus according to a preset program. Optionally, the touch-sensitive surface may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 808. Moreover, the touch controller can receive and execute a command sent from the processor 808. In addition, the touch-sensitive surface may be implemented by using various types, such as a resistive type, a capacitance type, an infrared type, and a surface sound wave type. In addition to the touch-sensitive surface, the input unit 803 may further include the another input device. Specifically, the another input device may include, but is not limited to, one or more of a physical keyboard, a functional key (such as a volume control key or a switch key), a track ball, a mouse, and a joystick.

The display unit 804 may be configured to display information input by the user or information provided for the user, and various graphical user ports of the mobile terminal. The graphical user ports may be formed by a graph, a text, an icon, a video, and any combination thereof. The display unit 804 may include a display panel. Optionally, the display panel may be configured by using a liquid crystal display (LCD), an organic light-emitting diode (OLED), or the like. Further, the touch-sensitive surface may cover the display panel. After detecting a touch operation on or near the touch-sensitive surface, the touch-sensitive surface transfers the touch operation to the processor 808, so as to determine a type of a touch event. Then, the processor 808 provides corresponding visual output on the display panel according to the type of the touch event. Although, in FIG. 8, the touch-sensitive surface and the display panel are used as two separate parts to implement input and output functions, in some embodiments, the touch-sensitive surface and the display panel may be integrated to implement the input and output functions.

The mobile terminal may further include at least one sensor 805, such as an optical sensor, a motion sensor, and other sensors. Specifically, the optical sensor may include an ambient light sensor and a proximity sensor. The ambient light sensor may adjust luminance of the display panel according to brightness of the ambient light. The proximity sensor may switch off the display panel and/or backlight when the mobile terminal is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone attitude (such as switching between horizontal and vertical screens, a related game, and attitude calibration of a magnetometer), a related function of vibration identification (such as a pedometer and a knock). Other sensors, such as a gyroscope, a barometer, a hygrometer, a thermometer, and an infrared sensor, which may be configured in the mobile terminal are not further described herein.

The audio circuit 806, a loudspeaker, and a microphone may provide audio interfaces between the user and the mobile terminal. The audio circuit 806 may transmit, to the loudspeaker, a received electric signal converted from received audio data. The loudspeaker converts the electric signal into a sound signal for output. On the other hand, the microphone converts a collected sound signal into an electric signal. The audio circuit 806 receives the electric signal and converts the electric signal into audio data, and outputs the audio data to the processor 808 for processing. Then, the processor 808 sends the audio data to, for example, another terminal by using the RF circuit 801, or outputs the audio data to the memory 802 for further processing. The audio circuit 806 may further include an earplug jack, so as to provide communication between a peripheral earphone and the mobile terminal.

The mobile terminal may help, by using the transmission module 807 (e.g. Wi-Fi module), a user to receive and send an e-mail, browse a webpage, and access stream media, and the like, which provides wireless broadband Internet access for the user. Although FIG. 8 shows the transmission module 807, it may be understood that, the wireless communications unit is not a necessary component of the mobile terminal, and can be ignored according to demands without changing the scope of the essence of the present disclosure.

The processor 808 is a control center of the mobile terminal, and connects various parts of the terminal by using various interfaces and lines. By running or executing the software program and/or module stored in the memory 802, and invoking data stored in the memory 802, the processor 808 performs various functions and data processing of the mobile terminal, thereby performing overall monitoring on the mobile phone. Optionally, the processor 808 may include one or more processing cores. Preferably, the processor 808 may integrate an application processor and a modem. The application processor mainly processes an operating system, a user interface, an application program, and the like. The modem mainly processes wireless communication. It may be understood that, the foregoing modem may not be integrated into the processor 808.

The mobile terminal further includes the power supply 809 (such as a battery) for supplying power to the components. Preferably, the power supply may be logically connected to the processor 808 by using a power supply management system, thereby implementing functions, such as charging, discharging, and power consumption management, by using the power supply management system. The power supply 809 may further include any component, such as one or more direct current or alternate current power supplies, a re-charging system, a power supply fault detection circuit, a power supply converter or an inverter, and a power supply state indicator.

The mobile terminal could further comprise a camera, a Bluetooth module or any other module. In this embodiment, the processor 808 could load one or more application programs into the memory 802 and execute the application programs to perform all kinds of functions.

The terminology used herein is for the purpose of describing particular embodiments only and is not intended to be limiting of the invention. As used herein, the singular forms “a”, “said” and “the” are intended to include the plural forms as well, unless the context clearly indicates otherwise. It will be understood that the term “and/or,” when used in this specification, specify one or more associated elements, alone or in combination, are provided. It will be further understood that the terms “first,” “second,” “third,” and “fourth,” when used in this specification, claim and drawings, are used to distinguish different objects, rather than to describe a specific order. It will be further understood that the terms “comprises” and/or “comprising,” when used in this specification, specify the presence of stated features, products, steps, operations, elements, and/or components, but do not preclude the presence or addition of one or more other features, products, steps, operations, elements, components, and/or groups thereof.

Above are embodiments of the present invention, which does not limit the scope of the present invention. Any modifications, equivalent replacements or improvements within the spirit and principles of the embodiment described above should be covered by the protected scope of the invention.

1. A charging/discharging structure, comprising: a main board, a hardware charging connector, a sub-circuit board, a flexible printed circuit (FPC), a transistor, a charging management circuit and at least two power storage modules; the main board comprising a processor; wherein a charger is electrically connected to the sub-circuit board through the hardware charging connector; the sub-circuit board is electrically connected to the main board through the FPC; the main board is electrically connected to the power storage module through the charging management circuit; the transistor is electrically connected to the charging management circuit; when the processor detects that the charger is electrically connected to the sub-circuit board, the processor outputs a control command to the charging management circuit; and when the charging management circuit receives the control command, the charging management circuit controls a voltage and a current of the power storage modules to charge/discharge the power storage modules.

2. The charging/discharging structure of claim 1, wherein a number of the charging management circuits matches a number of the power storage modules.

3. The charging/discharging structure of claim 2, wherein the power storage modules comprise a first storage module and a second storage module, and the charging management circuit comprises a first charging management circuit and a second charging management circuit.

4. The charging/discharging structure of claim 3, wherein the first charging management circuit is electrically connected to the first power storage module; the first charging management circuit increases the current according to a charging command outputted by the processor to charge the first power storage module; the second charging management circuit is electrically connected to the second power storage module; the second charging management circuit increases the current according to a charging command outputted from the processor to charge the second power storage module; and the first power storage module and the second power storage module are independently charged.

5. The charging/discharging structure of claim 3, wherein the first charging management circuit controls the first power storage module to perform a discharging operation according to a discharging command outputted from the processor; the second charging management circuit controls the second power storage module to perform a discharging operation according to a discharging command outputted from the processor; and the first power storage module and the second power storage module are independently discharged.

6. The charging/discharging structure of claim 1, wherein the charging management circuit is a charging management set, comprising a plurality of sub-charging management circuits; wherein a number of the sub-charging management circuits matches a number of the power management modules.

7. The charging/discharging structure of claim 6, wherein the power storage modules comprise a first power storage module and a second power storage module; and the charging management circuit comprises a third charging management circuit and a fourth charging management circuit.

8. The charging/discharging structure of claim 7, wherein the third charging management circuit is electrically connected to the fourth charging management circuit through the transistor; when the charging management circuit receives a charging command outputted by the processor, the transistor controls the third charging management circuit to be connected to the fourth charging management circuit such that the third charging management circuit increase a current according to the charging command to charge the first power storage module; the second charging management circuit increases a current according to the charging command to charge the second power storage module; and the first power storage module and the second power storage module are independently charged.

9. The charging/discharging structure of claim 8, wherein when the charging management circuit receives a discharging command outputted by the processor, the transistor controls the third charging management circuit and the fourth charging management circuit to break their parallel connection such that the third charging management circuit controls the first power storage module to perform a discharging operation according to the discharging command; the fourth charging management circuit controls the second power storage module to perform a discharging operation according to the discharging command; and the first storage power and the second power storage module are independent and perform the discharging operations according to a predetermined order.

10. The charging/discharging structure of claim 1, wherein the main board further comprises a power detection circuit electrically connected to the processor.

11. A charging method, applied in a charging/discharging structure, the charging/discharging structure comprising: a main board, a hardware charging connector, a sub-circuit board, a flexible printed circuit (FPC), a transistor, a charging management circuit and at least two power storage modules; the main board comprising a processor; wherein a charger is electrically connected to the sub-circuit board through the hardware charging connector; the sub-circuit board is electrically connected to the main board through the FPC; the main board is electrically connected to the power storage module through the charging management circuit; the transistor is electrically connected to the charging management circuit; when the processor detects that the charger is electrically connected to the sub-circuit board, the processor outputs a control command to the charging management circuit; and when the charging management circuit receives the control command, the charging management circuit controls a voltage and a current of the power storage modules to charge/discharge the power storage modules,
the charging method comprising:
when detecting that the at least two power storage modules meet a predetermined first condition, connecting the charger through the hardware charging connector to confirm that a mobile terminal charging system structure is in a charging state;
transferring a charging command to the charging management circuit such that the first charging management circuit charges the first power storage module according to a charging command; the second charging management circuit charges the second power storage module according to a charging command; wherein the first power storage module and the second power storage module are independently charged; and
when detecting that the power storage modules meet a second condition, stop a charging operation.

12. The charging method of claim 11, wherein the first condition is that an overall power of the power storage modules is lower than a first threshold.

13. The charging method of claim 12, wherein the step where the charging management circuit controls the at least two power storage modules to perform a charging operation comprises:
the first charging management circuit charges the first power storage module according to a charging command; and
the second charging management circuit charges the second power storage module according to a charging command;
wherein the first power storage module and the second power storage module are independently charged.

14. A charging method, comprising:
detecting a remaining power of at least two power storage modules; and
utilizing a charging management circuit to output a control command to control the at least two power storage modules to perform a charging/discharging operation according to the remaining power of the at least two power storage modules and a predetermined rule;
wherein the control command comprises a charging control command and a discharging control command.

15. The charging method of claim 14, wherein the at least two power storage modules comprise a first power storage module and a second power storage module, and the charging management circuit comprises a first charging management circuit and a second charging management circuit.

16. The charging method of claim 14, wherein the predetermined rule comprises a first predetermined rule and a second predetermined rule.

17. The charging method of claim 16, wherein the first predetermined rule comprises:
setting a charging/discharging structure in a charge-requiring state if the remaining power of the at least two power storage modules is lower than the first predetermined threshold.

18. The charging method of claim 16, wherein the second predetermined rule comprises:
if a difference between a remaining power of the first power storage module and a remaining power of the second power storage module is larger than the second predetermined threshold, comparing the remaining power of the first power storage module with the remaining power of the second power storage module, setting a predetermined power module state and outputting a control command to the charging management circuit according to the predetermined power module state.

19. The charging method of claim 18, wherein the step of comparing the remaining power of the first power storage module with the remaining power of the second power storage module and setting a predetermined power module state comprises:
when detecting the remaining power of the first power storage module is greater than the remaining power of the second power storage module, setting the predetermined storage module state of the first power storage module as a discharging state and setting the predetermined power storage state of the second power storage module as a charging state; and
when detecting the remaining power of the second power storage module is greater than the remaining power of the first power storage module, setting the predetermined storage module state of the second power storage module as a discharging state and setting the predetermined power storage state of the first power storage module as a charging state.

20. The discharging method of claim 18, wherein the step of utilizing the charging management circuit to output the control command to control the at least two power storage modules to perform the charging/discharging operation according to the remaining power of the at least two power storage modules and the predetermined rule comprises:
utilizing the first charging management circuit to output a control command according to the predetermined power storage module state corresponding to the first power storage module to control the first power storage module to perform a charging/discharging operation; and
utilizing the second charging management circuit to output a control command according to the predetermined power storage module state corresponding to the second power storage module to control the second power storage module to perform a charging/discharging operation.
